(19) United States
(12) Patent Application Publication
(10) Pub. No.: US 2024/0116124 A1
(43) Pub. Date: Apr. 11, 2024

(54) JOINING HARDPOINT FOR CAST COMPONENTS

(71) Applicant: Honda Motor Co., Ltd., Tokyo (JP)

(72) Inventors: Ryan M. HAHNLEN, Dublin, OH (US); Duane Trent DETWILER, Powell, OH (US)

(21) Appl. No.: 17/962,054

(22) Filed: Oct. 7, 2022

(51) Int. Cl. B23K 11/20; B21J 15/02; B23K 11/00

(52) U.S. Cl. CPC B23K 11/20; B21J 15/025; B23K 11/0066; B23K 2103/04

(57) ABSTRACT

A multi-component structure includes a first component of a first material, an insert of a second material different than the first material, a retainer, and a second component. The first component includes a recess in which the insert is arranged. The retainer secures the insert in the recess by covering a portion of a top surface of the insert. To accomplish this, a) the retainer is joined to the first component by a solid-state weld or by solid-state additive manufacturing, or b) the base component and the retainer are of a one-piece construction and the retainer is of the first material. The second component is attached to the insert by a mechanical connection or by a resistance spot weld between the second component and the insert.

### BACKGROUND

Cast aluminum components are porous structures, and thus are joined to other components to form structures via mechanical fasteners or a fusion welding process such as Metal Inert Gas (MIG) or Tungsten Inert Gas (TIG) welding. However, these joining methods have drawbacks.

Fusion welding methods such as MIG or TIG are relatively slow compared to Resistance Spot Welding (RSW) and may also require separate equipment. Using RSW in cast aluminum applications also come with challenges such as high current requirement and increased weld tip maintenance. Moreover, RSW is not typically used for joining to cast aluminum components because of concerns over porosity in the cast workpiece, which concerns include the potential for porous aluminum components to collapse during the welding process or to weaken in the region near the weld, thus potentially causing a failure of the structure under lower-than-expected stress/strain.

As for the use of mechanical fasteners instead of welding, their use may require increased investment and maintenance, over and above what is required in a production facility that also employs fusion welding joining methods. Further, the fasteners themselves add weight to a joined structure and may require inventory tracking in the production facility.

### BRIEF DESCRIPTION

According to one aspect, a cast assembly includes a base component, a retainer, and an insert. The base component is of a first material and includes a recess. The insert is of a second material different than the first material, and is arranged in the recess. The retainer secures the insert in the recess by covering a portion of a top surface of the insert. Either, a) the retainer is joined to the base component by a solid-state weld or by solid-state additive manufacturing, or b) the base component and the retainer are of a one-piece construction and the retainer is of the first material.

According to another aspect, a multi-component structure includes a first component, a retainer, an insert, and a second component. The first component is of a first material and includes a recess. The insert is of a second material different than the first material, and is arranged in the recess. The retainer secures the insert in the recess by covering a portion of a top surface of the insert. Either, a) the retainer is joined to the first component by a solid-state weld or by solid-state additive manufacturing, or b) the base component and the retainer are of a one-piece construction and the retainer is of the first material. The second component is attached to the insert by a mechanical connection or by a resistance spot weld between the second component and the insert.

According to another aspect, a method of making a multi-component structure includes providing of a first component and an insert. The first component is of a first material. The insert is of a second material different from the first material. The method includes arranging the insert in a recess of the first component, retaining the insert in the recess by arranging a retainer over the recess and over the insert. Either a) the retainer is joined to the first component by solid-state welding or by solid-state additive manufacturing, or b) the base component and the retainer are of a one-piece construction and the retainer is of the first material. The method may further include providing a second component of a third material that is different from the first material, and joining the second component to the insert with a mechanical connection or a resistance spot weld.

### BRIEF DESCRIPTION OF THE DRAWINGS

FIG. 1 is a plan view of a cast assembly according to the present subject matter.

FIG. 2 is a side cross-section view of a cast assembly according to the present subject matter.

FIG. 3 is a side cross-section view of a cast assembly according to the present subject matter.

FIG. 4 is a plan view of a multi-component structure according to the present subject matter.

FIG. 5 is a side cross-section view of a multi-component structure according to the present subject matter.

FIG. 6 is a side cross-section view of a multi-component structure according to the present subject matter.

FIG. 7 is a side cross-section view of a multi-component structure according to the present subject matter.

FIG. 8 is a plan view of a multi-component structure according to the present subject matter.

FIG. 9 is a side cross-section view of a multi-component structure according to the present subject matter.

FIG. 10 is a side cross-section view of a multi-component structure according to the present subject matter.

FIG. 11 is a side cross-section view of a multi-component structure according to the present subject matter.

FIG. 12 is a side cross-section view of a cast assembly according to the present subject matter.

FIG. 13 is a side cross-section view of a multi-component structure according to the present subject matter.

FIG. 14 is a side cross-section view of a multi-component structure according to the present subject matter.

### DETAILED DESCRIPTION

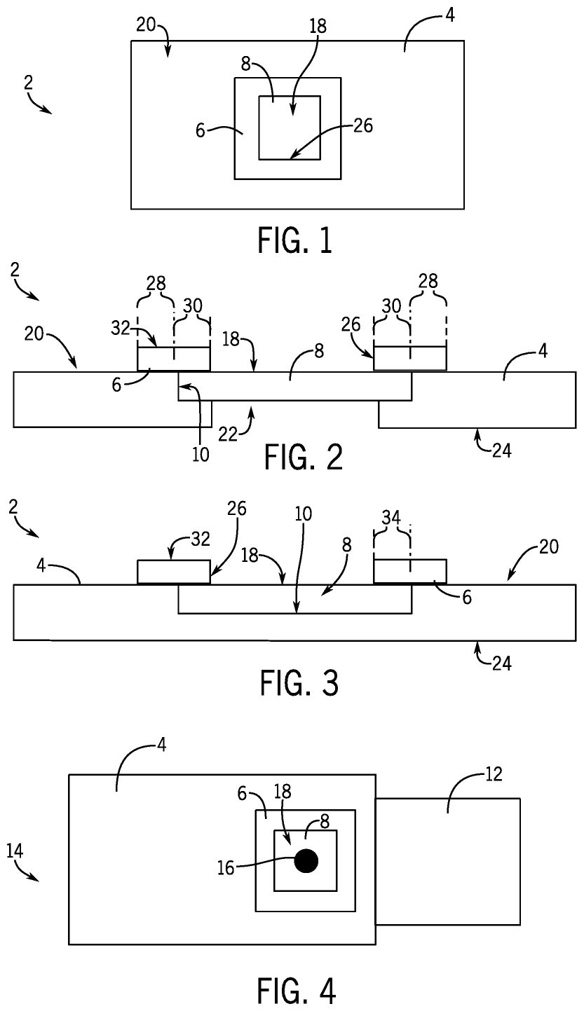

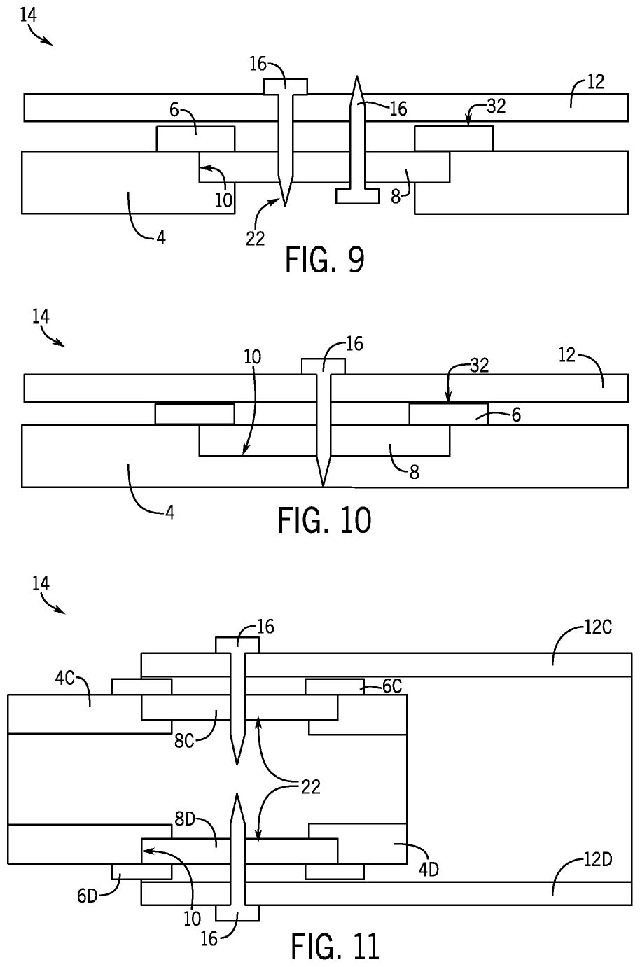

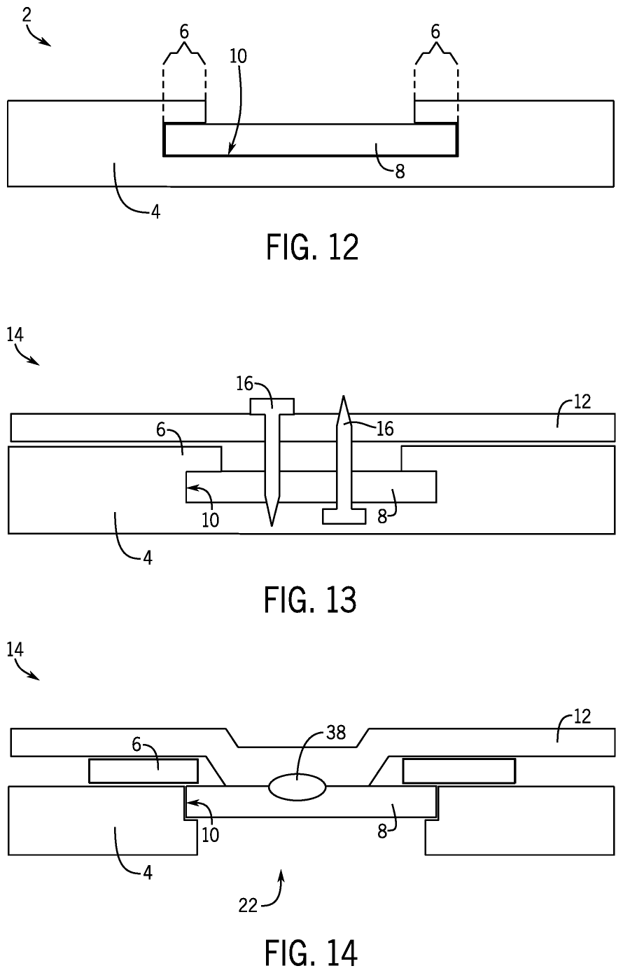

Referring to the figures, the present subject matter provides a cast assembly 2 including a first component (also referred to herein as a base component or a base) 4, a retainer 6, and an insert (also referred to herein as a hardpoint) 8. The base component 4 is of a first material (e.g. cast aluminum) and the insert 8 is of a second material (e.g. steel) different from the first material. The insert 8 is arranged in a recess 10 in the base component 4 and is retained therein by the retainer 6, which is joined to the base component 4 by a solid-state weld or by solid-state additive manufacturing (FIGS. 1-11 and 14) or is of a one-piece construction with the base component 4 (FIGS. 12-13). A multi-component structure 14 can be attained by connecting a second component 12 to the cast assembly 2, which can be accomplished by directly connecting the second component 12 to the insert 8 via a mechanical fastener 16 or a resistance spot weld (RSW) 38.

The cast assembly 2 and/or multi-component structure 14 may be used for any purpose, such as a vehicle structure, for example. However, the invention is not limited to this, and can be used for other purposes.

The invention produces a hardpoint 8 in the cast assembly 2 that can be used for connecting with the second component 12, thus more easily guaranteeing the integrity of the joint between the second component 12 and the cast assembly 2.

### First Component

The first component/base 4 includes the recess 10, in which the insert 8 is arranged, and in which the insert 8 is held by the retainer 6. The base 4 may be larger than the insert 8, thereby allowing the base 4 to contain the insert 8 in the recess 10. However, this may not be required, and the base 4 and insert 8 may be similar in size or the insert 8 may be larger than the base 4.

The base 4 is made of the first material, which is different from the second material of the insert 8. The first material may include, consist essentially of, or consist of aluminum or an aluminum alloy. The first material may be formed by a casting process to produce the base 4, thus making the base 4 a cast aluminum material, for example, a cast aluminum or cast aluminum alloy. However, this may not be required and the first material may be formed into the base 4 by other methods, including extrusion, rolling, forging, stamping, etc.

The recess 10 may have a shape that corresponds to a shape of the insert 8. This may allow for a close fit of the insert 8 in the recess 10 and/or a proper and/or fixed orientation of the insert 8 with respect to the recess 10 and thus to the base 4. This is depicted in the figures, where the insert 8 has a generally square shape from a top view (FIG. 1) and a height from a side view (FIGS. 2-3). The recess 10 may have a corresponding generally square shape from a top perspective and a corresponding depth, such that the insert 8 closely fits into the recess 10 in a specific fixed orientation(s), and may not be able to be rotated or otherwise moved within the recess 10. Alternatively, the insert 8 and the recess 10 may have a round shape to make manufacturing and assembly of the first component 4 easier. Moreover, the insert 8 may have a top surface 18 that is flush with a top surface 20 of the base 4. Such correspondence between the insert 8 and recess 10 may not be required however, and the shape of the insert 8 and the shape of the recess 10 from the top view may not be the same or even similar, and the height of the insert 8 and the depth of the recess 10 may not be the same or even similar, such that the insert 8 may only loosely sit in the recess 10 and its top surface 18 may be above or below (i.e. is not flush with) the top surface 20 of the base 4.

The recess 10 may be a blind hole (e.g. FIG. 3), or the base 4 may include a through hole 22 (e.g. FIG. 2) extending through the base 4 from the top surface 20 to a bottom surface 24 of the base 4. The through hole 22 may be aligned directly under the recess 10 as depicted in the figures. The through hole 22 may be smaller in area from a top view than the recess 10, and thus the insert 8 may be prevented from passing through the through hole 22 when inserted into the recess 10 from the top of the base 4 and may thus stay in the recess 10 with the help of the retainer 6. The through hole 22 may be included so as to allow the fastener 16 to be inserted through the insert 8 and through the second component 12 without necessarily contacting the base 4, and/or to allow the fastener 16 to be inserted through the insert 8 from either above or below the cast assembly 2. The through hole 22 may provide a region for material flow to occur when using a fastener 16 that is inserted using a thread-forming process such as flow drill screws. The through hole 22 may provide two-sided access to allow for an RSW 38 to be formed between the insert 8 and second component 12.

### Insert

The insert 8 is separate and distinct from the base 4, and in one non-limiting example is not overcast into the base 4 (FIGS. 1-11 and 14), and in one non-limiting example is overcast (i.e. overmolded) into the base 4 (FIGS. 12-13). The insert 8 may be smaller than the base 4, but this may not be required. When arranged and secured in the recess 10 in the base 4, the insert 8 may act as a hardpoint for the cast assembly 2, to which other components, such as the second component 12, can be attached to the cast assembly 2.

The insert 8 is made of the second material, which is different from the first material of the base 4. The second material may have higher tensile strength, higher yield strength, higher ultimate tensile strength, higher compressive strength, higher fatigue strength, higher torsion strength, higher sheer strength, greater creep resistance, higher hardness, and/or fewer defects than the first material. These superior properties of the second material compared to the first material allow the insert 8 to act as a hardpoint to which the second component 12 or other components can be directly attached. The attachment to the hardpoint is thus more secure than if the second component 12 or other components were attached directly to the base 4, since the first material of the base 4 may not be as strong as the second material of the insert 8.

The second material may include, consist essentially of, or consist of steel. The type of steel is not particularly limited and may be grades 304, 316, 409, 430 or others. The second material may be formed into the insert 8 by extrusion, rolling, forging, stamping, machining, casting, etc. In a non-limiting example, the insert 8 is a sheet of rolled steel. When in the recess 10, the insert 8 may cover/block the through hole 22 if present. The second material may differ from the first in its processing. In a non-limiting example, the base 4 may consist of a cast aluminum alloy, such as A380, whereas the insert 8 may consist of a wrought aluminum alloy belonging to the 5xxx, 6xxx, or 7xxx families. In this case, the wrought material of the insert 8 is more suitable for joining via RSW 38 or mechanical fasters 16 due it its lack of porosity defects.

### Retainer

The insert 8 is secured in the recess 10 by the retainer 6, which is a) secured to the base 4 by a solid-state joint between the retainer 6 and the base 4, e.g. by a solid-state weld between the retainer 6 and the base 4 or by forming the retainer 6 on the base 4 by solid-state additive manufacturing (FIGS. 1-11 and 14), or b) is of a one-piece construction with the base 4, e.g. by being cast along with the base 4 using the first material (FIGS. 12-13). The insert 8 may also be secured in the recess 10 by other supplementary means, such as by an adhesive arranged at the interface between the insert 8 and the base 4, e.g. in the recess 10 or by a solid-state weld also between the insert 8 and the retainer 6.

The retainer 6 may be made of various materials, including the first material (FIGS. 12-13), the second material, or other materials. In a non-limiting example, the retainer 6 includes steel.

As depicted in FIGS. 1-11 and 14, a portion of the retainer 6 overlays/covers at least a portion (e.g. a remainder 30) of the insert 8, and another portion (e.g. a perimeter 28) of the retainer 6 overlays/covers a portion of the base 4 adjacent to the recess 10. The retainer 6 has a square ring shape from a top view, with a square shape central opening 26. A perimeter 28 of the retainer 6 overlays/covers, and is connected by a solid state joint to, a portion of the base 4 surrounding the recess 10. Radially inside the perimeter, a remainder 30 of the retainer 6 overlays/covers the insert 8, and thus holds the insert 8 in the recess 10. That is, the retainer 6 covers only a periphery 34 of the top surface 18 of the insert 8 (and optionally covers the entire periphery 34), and a central portion 36 of the top surface 18 of the insert 8 is not covered by the retainer 6. The retainer 6 may have other shapes, which may or may not correspond to the shape of the recess 10. The retainer 6 may be a single-piece or multiple-pieces.

The retainer 6 may be initially formed, and then attached by solid state welding to the top surface 20 of the base 4. Alternatively, the retainer 6 may be formed, layer by layer, by solid state manufacturing directly on top of the base 4 and over the insert 8 to thereby be connected to the base 4 and to secure the insert 8 in the recess 10. The retainer 6 may also, but is not required to, be connected to the insert 8 via a solid state joint.

The retainer 6 is shown to stand proud of the top surface 20 of the base 4, however, this may not be required and a top surface 32 of the retainer 6 may be flush with the top surface 20 of the base 4. This may occur if the insert 8 is inlaid in the recess 10 at a level below the top surface 20 of the base 4, thus providing room above the insert 8 for the retainer 6 and the top surface 32 of the retainer 6 to be flush with the top surface 20 of the base 4.

In the case of the retainer 6 being a different material than the first material, the solid-state joint between the retainer 6 and the base 4 may inhibit corrosion (e.g. galvanic corrosion) developing at the joint.

As depicted in FIGS. 12-13, the retainer 6 may be formed integrally as part of a one-piece construction with the base 4, and is thus part of the base 4. The first material may be cast to form the base 4 and retainer 6, wherein the insert 8 is overmolded by the casting process into the recess 10, and wherein the recess 10 is formed by the base 4 and the retainer 6. In this aspect, the top surface of the retainer 6 may lie under the top surface of the base 4. In overmolding, the insert 8 may be preplaced in a die cast mold prior to the casting operation of the first material. During casting, the first material flows around and partially encapsulates the insert 8 to partially surround the insert 8 and forming the base 4 and the retainer 6 as a one-piece unit.

### Second Component

The second component 12 may be joined directly to the insert 8, and thus to the base 4 and cast assembly 2, to form the multi-component structure 14. The second component 12 is not particularly limited, and may be a third material. The third material may be different from the first material and/or different from the second material, however, this may not be required and the third material may be the same as the first material or be the same as the second material. The third material may include a variety of materials including metals, polymers, wood, etc. In a non-limiting example, the third material is steel.

The second component 12 may be arranged relative to the cast assembly 2 so that the fastener 16 may be inserted to extend through the second component 12 and through the insert 8 so as to join the second component 12 directly to the insert 8.

FIGS. 4-6 depict the multi-component structure 14, where the second component 12 is arranged below the cast assembly 2, and the insert 8 is arranged at a top of the base 4. In these figures, the retainer 6 is not load bearing, i.e. is not bearing pressure exerted by the second component 12 due to the connection formed by the fastener 16. In other words, the retainer 6 is not bearing the load of the second component 12 because the second component 12 does not contact the retainer 6, but contacts and thus presses against the first component 4. In compressive loads forcing the base 4 and second component 12 together, the underside of the base 4 will resolve the mechanical loads. In tensile load forcing the base 4 and second component 12 apart, the mechanical loads will transfer to the insert 8 via the joint(s) 16 which will bear upon the recess 10 of the base 4. In FIGS. 4-6, the second component 12 does not contact the insert 8. FIGS. 8-10 depict another multi-component structure 14, where the second component 12 is arranged above the cast assembly 2, and the insert 8 is arranged at a top of the base 4. In these figures, the retainer 6 is load bearing, i.e. bearing pressure exerted by the second component 12 due to the connection formed by the fastener 16, since it contacts and thus bears the load of the second component 12. In compressive loads forcing the base 4 and second component 12 together, the retainer 6 will bear the compressive mechanical loads in parallel with the joint(s) 16, insert 8, and recess 10 of the base. In tensile load forcing the base 4 and second component 12 apart, the mechanical loads will transfer to the insert 8 via the joint(s) 16 which will bear upon the retainer 6. In FIGS. 8-10, the second component 12 is not shown to contact the insert 8, however, contact between the second components 12 and the insert 8 may occur.

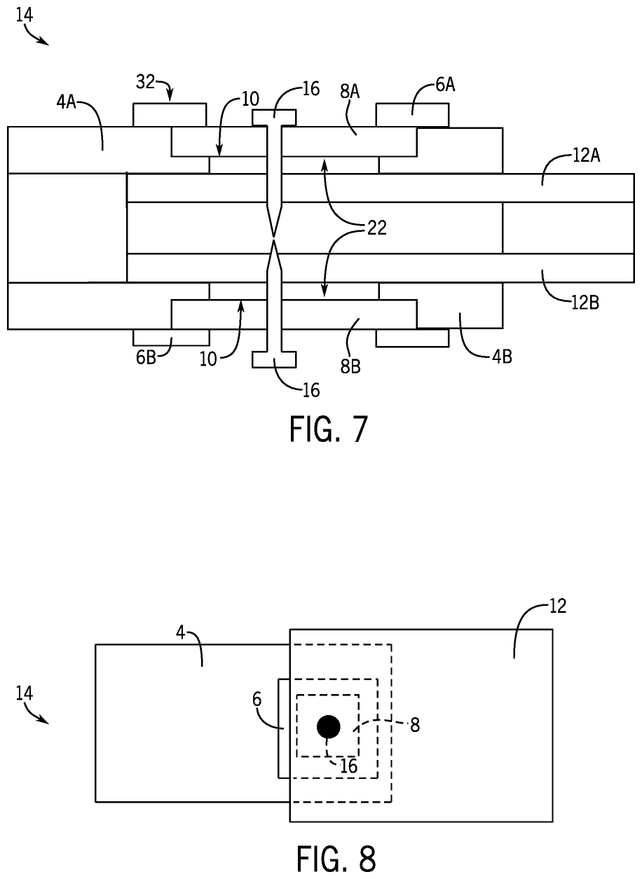

FIG. 7 depicts a cross-section of a multi-component structure where the base 4 and the second component 12 are comprised of nested hollow structures such as square or round tubes, where the base walls 4A, 4B of the cast assembly sandwich the walls 12A, 12B of the second component between them, and the respective inserts 8A, 8B are arranged on an outside of the respective base walls 4A, 4B. In this figure, the retainers 6A, 6B are not load bearing since they do not bear the load of the second components 12A, 12B. FIG. 11 depicts another cross-section of a multi-component structure 14 where the base 4 and the second component 2 are comprised of nested hollow structures, where the base walls 4C, 4D of a cast assembly are sandwiched by two walls 12C, 12D of a second component, and the respective inserts 8C, 8D are arranged on an outside of the respective base walls 4C, 4D. In this figure, the retainers 6C, 6D are load bearing since they bear the load of the second components 12C, 12D.

Where the second component 12 is arranged on the same side of the base 4 as the insert 8 (FIGS. 8-11), the retainer 6 may contact the second component 12 and may be load bearing. Where the second component 12 is arranged on the opposite side of the base 4 as the insert 8 (FIGS. 4-7), the retainer does not contact the second component 12, and thus does not bear pressure exerted by the second component 12 due to the connection formed by the fastener 16. Instead, the second component 12 may contact the base 4 and thus this pressure exerted by the second component 12 may be borne by the base 4.

### Fastener

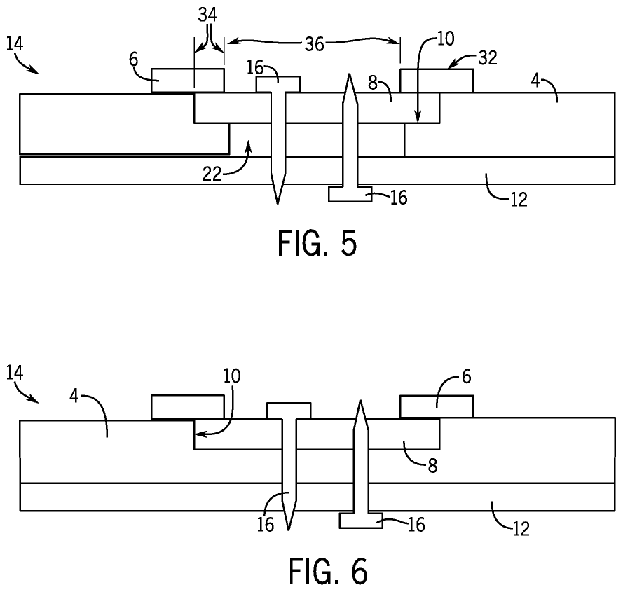

The fastener 16, if used, mechanically connects the second component 12 directly to the hard point of the insert 8. One or more fasteners 16 may be used to make this mechanical connection between the second component 12 and the insert 8. FIGS. 4, 7, 8, 10, and 11 show one fastener 16 being used secure one second component 12 to one insert 8. FIGS. 5, 6, and 9 show two fasteners 16 being used to secure one second component to one insert 8. More or less fasteners 16 can be used, such as three or more fasteners 16 being used secure one second component 12 to one insert 8. In FIG. 10 for example, three or more fasteners 16 could be used to secure the second component 12 to the insert 8. Alternatively, one fastener 16 may be used to secure two second components 12 to one or two inserts 8. In FIG. 7 for example, one fastener 16 could be used to secure both second components 12A, 12B to the two inserts 8A, 8B, by inserting the one fastener 16 though both second components 12A, 12B and through both inserts 8A, 8B.

The fastener 16 may be inserted from either the top or the bottom of the multi-component structure 14 so as to extend through the second component 12 and into the insert 8, and may optionally pass through the insert 8 and optionally penetrate and optionally pass through the base 4. As depicted in FIG. 10, the fastener 16 is inserted from the top of the multi-component structure 14 so as to connect the second component 12 to the insert 8. However, this is not required and the fastener 16 could be inserted from the bottom of the multi-component structure 14. As depicted in FIGS. 5, 6, and 9, two fasteners 16 are inserted from opposite sides of the multi-component structure 14 to secured the second component 12 to the insert 8, i.e. one from the top and one from the bottom of the multi-component structure 14. However, this is not required and the two fasteners 16 could be inserted from the same side of the multi-component structure 14 as the other, i.e. both inserted from the top or both inserted from the bottom of the multi-component structure 14.

The fastener 16 is not particularly limited, and may include a self-piercing rivet, a flow drill screw, a nail, a pop rivet, and a bolt. A combination of these may be used to connect the second component 12 to the insert 8. If more than one is used, the multiple fasteners 16 may be inserted from opposite sides of the multi-component structure 14 (FIGS. 5, 6, 9) or from the same side of the multi-component structure 14.

### Weld

A weld 38 may be used to connect the second component 12 directly to the hard point of the insert 8 (FIG. 14). The weld 38 is not particularly limited, and may include a resistance spot weld (RSW) 38, which is referred throughout this disclosure, or other types of welds. One or more RSWs 38 may be used to make this connection between the second component 12 and the insert 8. FIG. 14 shows one RSW 38 being used secure one second component 12 to one insert 8. However, the present subject matter is not so limited, and may utilize more than one RSW 38 to secure one second component to one insert 8. More or less RSWs 38 can be used, such as two or more RSWs 38 being used secure one second component 12 to one insert 8.

The RSW 38 may be formed by welding electrodes, one being inserted through the through hole 22, between the second component 12 and the insert 8.

### Multi-Component Structure

The multi-component structure 14 can include the first component 4, the insert 8, the retainer 6, the second component 12 and the fastener 16 or RSW 38. The multi-component structure is not particularly limited, and may be employed as, or as part of, any kind of structure, such as a component of a vehicle, a building, a tool, etc. In a non-limiting example, the multi-component structure 14 is part of a vehicle, such as an automobile.

### Methods

A method of making the cast assembly 2 includes providing the first component (i.e. the base) 4 and the insert 8. The insert 8 is arranged in the recess 10 in the first component 4. The retainer 6 is arranged over the first component 4, over the recess 10, and optionally over the insert 8, and a) is joined to the first component 4 by solid-state welding or by solid-state additive manufacturing or b) the base component 4 and the retainer 6 are of a one-piece construction and the retainer 6 is of the first material, to thereby retain the insert 8 in the recess 10 and thus secure the insert 8 to the first component 4.

The retainer 6 is arranged over the insert 8 and when joined to the first component 4, the joint is formed including by either (a) providing a pre-formed retainer 6 and then arranging the retainer 6 over the insert 8 and then securing the retainer 6 to the first component 4 by solid-state welding, or (b) building the retainer 6 in an additive manufacturing process directly on the first component 4 and over the insert 8. Either of these secures the insert 8 to the first component 4.

The solid state welding between the retainer 6 and the base 4 is not particularly limited, and may include friction welding (including friction stir welding), electric resistance welding, ultrasonic welding, diffusion welding, forge welding, roll welding, or similar process. The additive manufacturing process between the retainer 6 and the base 4 is not particularly limited, and may include building up the retainer 6 layer-by-layer on the first component 4 and over the insert 8. The additive manufacturing may include friction additive manufacturing (including friction stir additive manufacturing), sheet lamination (including ultrasonic additive manufacturing), material jetting (including cold spray additive manufacturing), powder bed fusion, or similar process.

The insert 8 may be secured to the first component 4 with additional securing means, such as by an adhesive used to adhere the insert 8 to the recess 10, and which may be applied to the insert 8 or to the recess 10 before the insert 8 is arranged in the recess 10. However, this may not be required, and the insert 8 may be retained in the recess 10 only by the solid-state welding or only by the solid-state additive manufacturing.

The insert 8 may be secured to the retainer 6 by a solid-state welding or solid-state additive manufacturing process. This process may be the same process as that which joined the retainer 6 to the base 4 or may be a separate process.

When the base component 4 and the retainer 6 are of a one-piece construction and the retainer 6 is of the first material, insert 8 may be placed in a mold and the first material may be cast or otherwise formed around the insert 8 and formed into the base 4 including the retainer 6.

A method of making the multi-component structure 14 may include the method of making the cast assembly 2. The method of making the multi-component structure 14 may further include providing the second component 12, and joining the second component 12 to the insert 8 by a mechanical connection or RSW 38, thus joining the second component 12 to the cast assembly 2. The mechanical connection may be made by at least one mechanical fastener 16. The mechanical fastener 16 may be selected from the group consisting of a self-piercing rivet, a flow drill screw, a nail, a pop rivet, and a bolt.

The methods may be performed manually, or partially or fully automatically.

The invention uses overmolding, solid state welding, or additive manufacturing to secure the hard point insert 8 into the base 4, and thus does not use a joining process that causes concerns about porosity or cracking impacting joint strength on the cast aluminum material of the base 4, which because of the cast aluminum, has porosity in the joint area. The overmolding, solid state welding, or additive manufacturing enables a dissimilar metal joint to be formed between the insert 8, the retainer 6, and the aluminum base 4. The low heat input of these methods avoids microstructure change of the casting of the base 4, avoids intermetallic formation between dissimilar metals between the base 4 and the steel insert 8 and retainer 6, and provides additional load paths for the joined second component 12 through the retainer 6 and insert 8.

The use of a solid-state weld or additive manufacturing processes to capture the insert 8 reduces heat input into the aluminum casting of the base 4, and maintains the ability to connect the insert 8 to the base 4 even though it is a different material than the base 4. Bonding around the perimeter of the insert 8 using the retainer 6 also increases the joint area as compared to directly connecting the insert 8 to the base 4, thus leading to lower stresses that are exerted by the second component 12. The stronger material of the insert 8 allows for increased load at the point of joining the second component 12 while distributing that load exerted by the second component 12 over a larger area in the casting material of the base 4 via the perimeter of the retainer 6.

By using a steel insert 8 in the aluminum casting of the base 4, then current factory infrastructure for steel-steel joints (i.e. between the insert 8 and the second component 12) is maintained. A sufficiently large insert 8 may also allow for multiple connections to be made between the second component 12 or multiple second components 12 and a single insert 8.

The invention thus allows for the joining a steel hardpoint insert 8 in the aluminum casting of the base 4, and the steel insert 8 can be secured to the cast base 4 using overmolding, solid-state welding, or additive manufacturing. By including a hardpoint insert 8, such as a piece of sheet metal, in the casting base 4, the integrity of the connection between them is more easily guaranteed. It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A cast assembly including:
a base component of a first material, the base component comprising a recess;
an insert of a second material different than the first material, the insert being arranged in the recess; and
a retainer securing the insert in the recess by covering a portion of a top surface of the insert;
wherein a) the retainer is joined to the base component by a solid-state weld or by solid-state additive manufacturing, or b) the base component and the retainer are of a one-piece construction and the retainer is of the first material

2. The cast assembly according to claim 1, wherein the base component and the recess are of the one-piece construction and the insert is overmolded into the recess.

3. The cast assembly according to claim 1, wherein the retainer covers only a periphery of the top surface.

4. The cast assembly according to claim 3, wherein a central portion of the top surface is not covered by the retainer.

5. The cast assembly according to claim 1, wherein the first material is cast aluminum or cast aluminum alloy.

6. The cast assembly according to claim 5, wherein the second material is steel.

7. The cast assembly according to claim 1, wherein the base component includes a through hole aligned directly under the recess.

8. The cast assembly according to claim 7, wherein the insert blocks the through hole.

9. The cast assembly according to claim 1, wherein the recess is a blind hole.

10. A multi-component structure comprising:
a first component of a first material, the first component comprising a recess;
an insert of a second material different than the first material, the insert being arranged in the recess;
a retainer securing the insert in the recess by covering a portion of a top surface of the insert, wherein a) the retainer is joined to the first component by a solid-state weld or by solid-state additive manufacturing, or b) the base component and the retainer are of a one-piece construction and the retainer is of the first material; and
a second component attached to the insert by a mechanical connection or by a resistance spot weld between the second component and the insert.

11. The multi-component structure according to claim 10, wherein:
the first material is cast aluminum or cast aluminum alloy;
the second material is steel; and
the second component includes a third material that is steel.

12. The multi-component structure according to claim 11, wherein the second component is attached to the insert by the mechanical connection, and the mechanical connection is made by at least one mechanical fastener selected from the group consisting of a self-piercing rivet, a flow drill screw, a nail, a pop rivet, and a bolt.

13. The multi-component structure according to claim 11, wherein the second component is not directly attached to the first component.

14. The multi-component structure according to claim 13, wherein the second component contacts the retainer and does not contact the insert or the first component.

15. The multi-component structure according to claim 11, wherein the second component contacts the first component and does not contact the retainer or the insert.

16. The multi-component structure according to claim 15, wherein:
the first component includes a through hole aligned directly under the recess;
the second component is attached to the insert by the mechanical connection and a mechanical fastener makes the mechanical connection; and
the mechanical fastener extends from the insert, through the through hole, to the second component.

17. A method of making a multi-component structure comprising:
providing of a first component and an insert, the first component being a first material, the insert being a second material different from the first material;
arranging the insert in a recess in the first component; and
retaining the insert in the recess by arranging a retainer over the recess and over the insert;
wherein a) the retainer is joined to the first component by solid-state welding or by solid-state additive manufacturing, or b) the base component and the retainer are of a one-piece construction and the retainer is of the first material.

18. The method according to claim 17, wherein:
the insert is retained in the recess only by the retainer;
the first material is cast aluminum or cast aluminum alloy;
the second material is steel; and
the retainer includes steel.

19. The method according to claim 17, further comprising:
providing a second component of a third material that is different from the first material; and
joining the second component to the insert with a mechanical connection or a resistance spot weld.

20. The method according to claim 19, wherein:
the second component is joined to the insert with the mechanical connection;
the mechanical connection is made by at least one mechanical fastener selected from the group consisting of a self-piercing rivet, a flow drill screw, a nail, a pop rivet, and a bolt; and
the mechanical fastener extends through the insert and through the second component, and optionally into the first component.
